(19) United States
(12) Patent Application Publication
(10) Pub. No.: US 2010/0220374 A1
(43) Pub. Date: Sep. 2, 2010

(54) POLYGON MIRROR SCANNER MOTOR

(75) Inventors: Masaki Sumi, Osaka (JP); Akimitsu Maetani, Osaka (JP); Yasushi Fukui, Osaka (JP)

Correspondence Address: Brinks Hofer Gilson & Lione/Panasonic, P.O. Box 10395, Chicago, IL, 60610, US

(73) Assignee: Panasonic Corporation, Osaka (JP)

(21) Appl. No.: 12/681,070

(22) PCT Filed: Feb. 6, 2008
(86) PCT No.: PCT/JP2008/000156

§ 371 Date: Mar. 31, 2010

(30) Foreign Application Priority Data
Oct. 1, 2007 (JP) 2007-257313

(51) Int. Cl. G02B 26/12

(52) U.S. Cl. 359/216.1

(57) ABSTRACT

A polygon mirror scanner motor includes rotor frame (12) having rotor magnet (13) cylindrically arranged thereon, bearing sleeve (14) fastened to the center of rotor frame (12), fixed shaft (17) having one end fixed to base substrate (19), and the other end for rotatably supporting bearing sleeve (14), and polygon mirror (11) placed on rotor frame (12). Rotor frame (12) has at least three projections (12a) on its one surface, and polygon mirror (11) is placed on the flame in abutment with projections (12a).

### TECHNICAL FIELD

The present invention relates to a polygon mirror scanner motor used for laser scanning of a laser printer, a laser copying machine, etc., and particularly, to a polygon mirror scanner motor adapted to high-speed rotation, high-speed starting, reduction in size, and long lifetime.

### BACKGROUND ART

In recent years, in a polygon mirror scanner motor (hereinafter appropriately and simply referred to as a “polygon motor”), reductions in size, thickness, and cost are further required with the propagation of an LBP (Laser Beam Printer). Simultaneously, as for rotational fluctuation, noise, plane tilting of a polygon mirror, high-precision performance needs to be maintained. Under these circumstances, reductions in thickness and cost have been attained by a configuration in which a bearing is fixed to an iron substrate, etc., and a rotary shaft is pivotally supported by this bearing, and high-precision and long lifetime have been attained by adopting a fluid bearing as a bearing.

Contrary to such a rotating-shaft type motor, a fixed-shaft type motor in which a bearing which is pivotally supported by a shaft fixed to a bracket, etc. rotates around the shaft is also conventionally suggested, for example, as disclosed in Patent Document 1.

FIG. 5 is a sectional view showing an example of a polygon motor that is a conventional fixed-shaft type.

In FIG. 5, bracket 801 is provided with annular protrusion 802. Stator core 803 is fixed to annular protrusion 802, and stator coil 804 is wound around stator core 803. Bracket 801 is attached and fixed to iron plate circuit board 805, and shaft 806 that is a fixed shaft is press-fitted into and fixed to a central portion of bracket 801. On the other hand, cylindrical sleeve bearing 811b which protrudes downward from flange portion 811 a is provided at hub 811 so as to protrude therefrom. Since herringbone grooves are formed in an inner peripheral surface of sleeve bearing 811b, dynamic pressure is generated during the rotation of the motor by lubricant interposed in a slight gap between shaft 806 and hub 811. Rotor 814 is fixed to outer peripheral surface 811c of sleeve bearing 811b. This rotor 814 is formed from resin including a ferrite magnetic component, and the inner peripheral surface of the rotor which faces stator core 803 is multi-pole magnetized. Moreover, polygon mirror 815 which forms a rectangular shape is placed on an upper portion of the flange portion 811a, and is pressed against and fixed to the flange portion from above by clamping spring 816.

By providing such a configuration, rotor 814 has a fixed-shaft type fluid bearing structure which rotates around shaft 806 that is a fixed shaft, and a bearing configuration similar to both-end supporting structure can be easily realized. That is, by providing such a fixed-shaft type, it was possible to suppress occurrence of precession such that a shaft is rotated while drawing a conical shape. In particular, since higher speed or colorization has been recently desired with the propagation of LBPs, the polygon motor also requires higher speed rotation, such as 30,000 to 50,000 rpm. In such high-speed rotation, an influence that the precession which is easy to occur in the rotating-shaft type described above exerts on a dynamic pressure bearing may become extremely large. As a result, there is a possibility that bearing lifetime is markedly reduced. For this reason, a polygon motor having the configuration of a fixed-shaft type as shown in FIG. 5 is being reconsidered.

Moreover, when an attempt to realize a polygon motor corresponding to high speed is made, the weight of a rotor easily influences characteristics of high-speed rotation or high-speed starting. Therefore, how the weight of the rotor is saved remains to be solved. For this reason, for example, as disclosed in Patent Document 2, a technique of reducing the number of parts of the rotor to reduce the cost, and suppressing an increase in the inertia of a whole rotary body achieve high-speed starting of the motor is also suggested.

FIG. 6 is a sectional view showing an example of a polygon mirror driving device based on such a conventional rotating-shaft type.

In FIG. 6, a conventional polygon mirror driving device has rotary shaft 903 rotatably supported by bearing 902 held in housing 901, and rotary shaft 903 is integrally combined with rotor 904. Rotor 904 constitutes a motor along with stator 906 on motor substrate 905 fixed to housing 901. Stator 906 has core 906a which is integral with motor substrate 905, and coil 906b wound around this core. A polygon mirror 907 is pressed against rotor 904 bonded to rotary shaft 903 by hold-down spring 908 mounted on the upper end of rotary shaft 903, and these are integrally combined. Rotor 904 is formed from a plastic magnet with good cuttability, and has tubular portion 904a which surrounds coil 906b, and disc portion 904b which allows polygon mirror 907 to be placed thereon. Reference plane 904c which is finished with high surface precision by cutting is formed on the upper face of disc portion 904b.

As such, the conventional polygon mirror driving device is configured such that polygon mirror 907 is made to abut on reference plane 904c of rotor 904, which is finished by cutting, by hold-down spring 908. This eliminates the need for a flange which has conventionally been interposed between the polygon mirror and the rotor, and achieves reductions in size and thickness along with reduction in cost by reduction in the number of assembly parts. By omitting the flange, the inertia of the whole rotary body including the polygon mirror and the rotor can be reduced, and the start-up time of the motor can be shortened.

However, in the case of the configuration like Patent Document 1, it is possible to suppress the precession with a simple configuration on the basis of the fixed-shaft type. However, for example, flange portion 811 a shown in FIG. 5 is required. Therefore, there is a problem in that the weight of the whole rotary body increases, and has an adverse effect on characteristics of high-speed rotation or high-speed starting as described above. Especially, in a case where metal cutting parts with heavy specific gravity are used for hub 811, etc. shown in FIG. 5, the position of the center of gravity of the rotor is apt to become high and unstable. For this reason, during high-speed rotation, the whirling motion such that the rotor rotates while vibrating in the radial direction becomes large, and the load to the bearing supporting the rotor also becomes heavy. As a result, this will also have an adverse effect on durability.

In the case of the configuration like Patent Document 2, parts, such as flange portion 811a shown in FIG. 5 can be reduced. Therefore, the weight of the whole rotary body can also be reduced, and a configuration adapted to high-speed starting is obtained. However, since a structure where the bearing which receives the rotary shaft is provided in a lower portion of the whole rotary body like the bearing 902 of FIG. 6, there is a problem in that the precession based on the rotating-shaft type is apt to occur. Moreover, since a configuration in which the rotary shaft and the internal diameter of the polygon mirror are directly fitted together is provided, it is extremely difficult to reduce the internal diameter of the polygon mirror to about the diameter of the rotary shaft in terms of the machining of manufacturing the polygon mirror. For this reason, actually, a spacer, such as a rotor boss, should be inserted between the rotary shaft and the internal diameter of the polygon mirror. Since the rotor is formed from a plastic magnet, there is a possibility that a crack may be created due to the centrifugal force added to the rotor during high-speed rotation.
[Patent Document 1] Japanese Patent Unexamined Publication No. 7-336970
[Patent Document 2] Japanese Patent Unexamined Publication No. 10-96872

### SUMMARY OF THE INVENTION

In order to solve the above problems, the polygon mirror scanner motor of the invention is a polygon mirror scanner motor including a stator part loaded on a base substrate, and including a stator core around which a stator coil is wound, and a rotor part including a rotor magnet arranged to face the stator core, and having a polygon mirror loaded thereon. The rotor part includes a rotor frame formed substantially in the shape of a cup, made by a magnetic metal material and having the rotor magnet arranged on the inner peripheral side of a cylindrical portion thereof, a bearing sleeve fastened to the center of the rotor frame, and a polygon mirror placed on the rotor frame. The stator part includes a fixed shaft having one end fixed to the base substrate. The bearing sleeve is rotatably supported at the other end of the fixed shaft. The rotor frame has at least three projections on its one surface, and has the polygon mirror placed thereon in abutment with the projections.

By such a configuration, since a fixed-shaft type structure is provided such that the bearing sleeve integrated with the rotor frame is supported by the fixed-shaft fixed to the base substrate, a bearing configuration similar to a both-end supporting structure is obtained, and generation of precession can be suppressed. Moreover, since a configuration in which the polygon mirror is supported by at least three projections provided on one surface of the rotor frame is provided, it is not necessary to provide a flange for allowing the polygon mirror to be placed thereon, a rotor boss interposed between a rotary shaft and the inner diameter of the polygon mirror, etc., and it is possible to reduce the weight and thickness of the whole rotary body including the bearing sleeve and the rotor frame. Since the position of the center of gravity of the whole rotary body becomes low, the whirling motion of the rotor during high-speed rotation can also be suppressed. Since the clearance between a polygon mirror and the rotor frame can be reduced, wind noise during rotation can also be reduced. Also, since the rotor magnet is covered with the rotor frame made of a magnetic metal material, breakage of the rotor magnet resulting from the centrifugal force during high-speed rotation can be prevented.

Moreover, by providing a configuration such that the polygon mirror is placed on the three projections in abutment therewith, the polygon mirror can be placed by so-called three-point supporting, and a stable reference plane for placing the polygon mirror can be realized.

### BRIEF DESCRIPTION OF THE DRAWINGS

FIG. 1 is a sectional view of a polygon mirror scanner motor in an embodiment of the invention.

FIG. 2 is a perspective view of a rotor frame of the polygon mirror scanner motor.

FIG. 3 is a view showing an aspect of a cross-section in which a bearing sleeve and the rotor frame are fixed by a jig.

FIG. 4 is a view showing the aspect in an oblique direction.

FIG. 5 is a sectional view showing an example of a polygon motor that is a conventional fixed-shaft type.

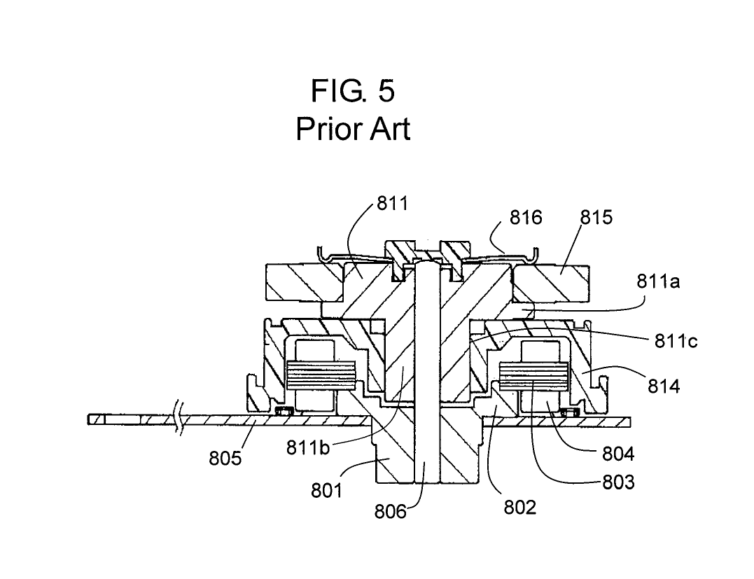

FIG. 6 is a sectional view showing an example of a polygon mirror driving device based on a conventional rotating-shaft type.

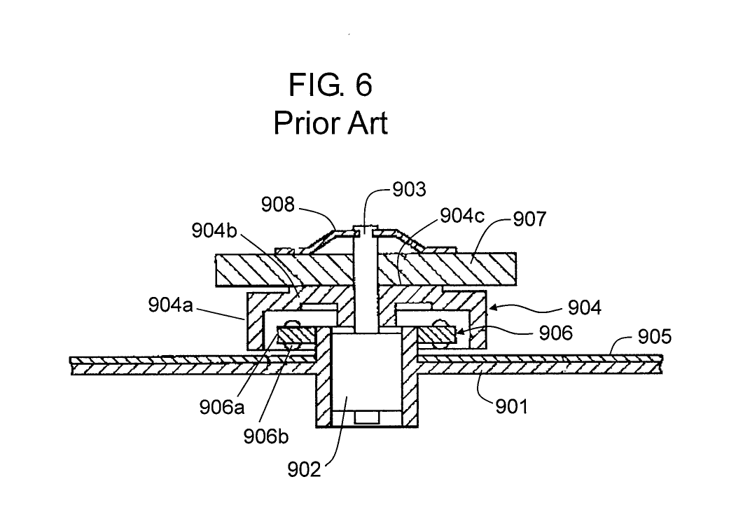

### DESCRIPTION OF REFERENCE NUMERALS AND SIGNS

11, 815, 907: POLYGON MIRROR
12: ROTOR FRAME
12a: PROJECTING PORTION
12b: STEPPED PORTION
13: ROTOR MAGNET
14: BEARING SLEEVE
15: THRUST PLATE
16: BEARING THRUST PORTION
17: FIXED SHAFT
18a, 803: STATOR CORE
18b, 804: STATOR COIL
19: BASE SUBSTRATE
20: DYNAMIC PRESSURE BEARING
20a, 20b: DYNAMIC PRESSURE GENERATING GROOVE
21, 908: HOLD-DOWN SPRING
22: FIXING PIN
80: CHUCK JIG
81: HOLD-DOWN JIG
82: RECEIVING JIG
83: FRAME REGULATING JIG
801: BRACKET
802: ANNULAR PROJECTING PORTION
805: IRON PLATE CIRCUIT BOARD
806: SHAFT
811: HUB
811a: FLANGE PORTION
811b: SLEEVE BEARING
811c: OUTER PERIPHERAL SURFACE
814, 904: ROTOR
816: CLAMP SPRING
901: HOUSING
902: BEARING
903: ROTARY SHAFT
904a: TUBULAR PORTION
904b: DISC PORTION
904c: REFERENCE PLANE
905: MOTOR SUBSTRATE
906: STATOR
906a: CORE
906b: COIL

### DETAILED DESCRIPTION OF PREFERRED EMBODIMENT

Hereinafter, an embodiment of the invention will be described with reference to the drawings.

Embodiment

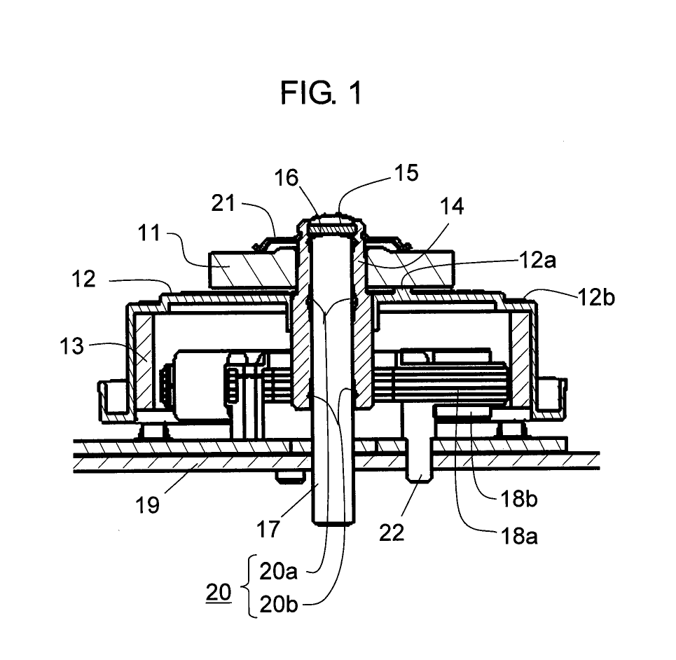

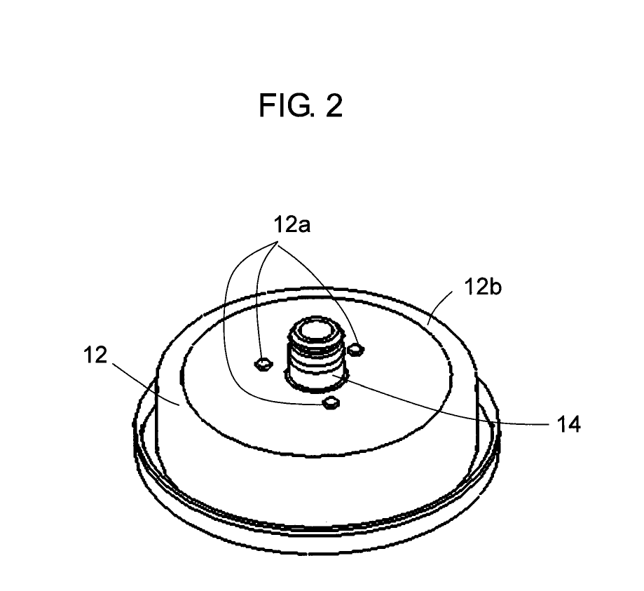

FIG. 1 is a sectional view of a polygon mirror scanner motor in the embodiment of the invention. Additionally, FIG. 2 is a perspective view of a rotor frame of the polygon mirror scanner motor in the embodiment of the invention.

As shown in FIG. 1, in this polygon mirror scanner motor, stator core 18a around which stator coil 18b is wound is loaded on base substrate 19, and fixed shaft 17 is fixed to base substrate 19. Fixed shaft 17 rotatably supports bearing sleeve 14 to which rotor frame 12 is fastened. That is, bearing sleeve 14 is formed substantially in the shape of a cylinder having an opening at one end, and fixed shaft 17 is inserted into an inner peripheral side of bearing sleeve 14 via the opening. Thrust plate 15 made of resin which constitutes bearing thrust portion 16 is arranged at the other end of the inner peripheral side of bearing sleeve 14, and thereby, bearing sleeve 14 receives fixed shaft 17 in the thrust direction. Moreover, dynamic pressure bearing 20 in the radial direction is configured on the inner peripheral side of bearing sleeve 14. In this way, fixed shaft 17 is fixed to base substrate 19 at one end in the axial direction thereof, and rotatably supports bearing sleeve 14 at the other end.

As shown in FIG. 2, rotor frame 12 is formed substantially in the shape of a cup by pressing work of a magnetic metal material, and forms a shape including a circular top surface portion that is its one surface, and a tubular portion which protrudes cylindrically from a peripheral edge of the top surface portion. In rotor frame 12, the top surface portion has an opening at the center thereof, bearing sleeve 14 is fastened so as to pass through the opening at the center of the top surface portion, and rotor magnet 13 is cylindrically arranged so as to face stator core 18a inside the cylindrical portion of rotor frame 12. Additionally, rotor frame 12 has a plurality of projections 12a at the top surface portion. Polygon mirror 11 is placed so as to abut on projections 12a, and polygon mirror 11 is pressed against and fixed onto on projections 12a of rotor frame 12 by hold-down spring 21.

In this way, the polygon motor of this embodiment has a stator part including base substrate 19, stator core 18a around which stator coil 18b is wound, and fixed shaft 17 fixed to base substrate 19, and a rotor part including bearing sleeve 14 which receives fixed shaft 17, rotor frame 12 in which rotor magnet 13 is arranged, and polygon mirror 11 loaded on rotor frame 12. Since the polygon motor is configured such that the rotor part is pivotally supported by fixed shaft 17 fixed to base substrate 19, the polygon motor of this embodiment is a fixed-shaft type motor.

The polygon motor of this embodiment is characterized by having a configuration in which polygon mirror 11 is placed on projections 12a provided at the top surface portion of rotor frame 12. Thereby, this polygon motor reduces parts, such as a flange and a rotor boss, which has conventionally been required in order to place the polygon mirror, and reduces the weight and thickness of a rotor part including the bearing sleeve and the rotor frame. Moreover, since not the whole top surface portion of rotor frame 12 but only projections 12a may be formed with high precision by punching work, finish machining by cutting work is also unnecessary.

Next, the configuration of the polygon motor of this embodiment will be described in more detail. In addition, description will be made below with a direction in which the rotor part, such as the rotor frame, is arranged on base substrate 19 being defined as an upper direction, and a direction opposite to the above direction being defined as a lower direction.

First, base substrate 19 is composed of, for example, an iron substrate, etc., and the polygon motor is mounted on a printer apparatus, etc. via this base substrate 19. Additionally, base substrate 19 includes a circuit board on which circuit elements for driving the polygon motor are loaded. Along with this, Stator core 18a which magnetic bodies are laminated is loaded on base substrate 19. Stator core 18a is wound stator coil 18b which generates torque with rotor magnet 13. Stator core 18a is fixed to base substrate 19 by a plurality of fixing pins 22.

Moreover, a circular through hole is formed in base substrate 19, and fixed shaft 17 is inserted into this through hole. That is, in an assembling process of this polygon motor, fixed shaft 17 is strongly fixed to base substrate 19, for example, by laser-welding a junction between fixed shaft 17 and the through hole at the rear surface of base substrate 19. Especially, in the polygon motor of this embodiment, the weight of the rotor part is reduced as described above. Therefore, the fixing strength of fixed shaft 17 can be reduced. For this reason, this polygon motor can be made into a structure such that fixed shaft 17 is directly fixed to base substrate 19 by laser welding without requiring parts, such as a bracket, for attaching fixed shaft 17 to base substrate 19. Since this can reduce the number of parts and the lower the height of protruding portions of base substrate 19 in the lower direction, the motor can be made thin.

Next, fixed shaft 17 is fixed to base substrate 19 in this way, and bearing sleeve 14 is rotatably supported by fixed shaft 17 protruding in the upper direction. For example, dynamic pressure generating grooves like herringbone grooves are formed in the inner peripheral cylindrical surface of bearing sleeve 14 as dynamic pressure bearing 20 in the radial direction. This embodiment shows an example in which two sets of dynamic pressure generating grooves of upper dynamic pressure generating grooves 20a and lower dynamic pressure generating grooves 20b are formed in the inner peripheral surface of bearing sleeve 14. In addition, a configuration in which dynamic pressure generating grooves may be formed on the side of fixed shaft 17, i.e., in a shaft surface, in abutting surfaces between fixed shaft 17 and bearing sleeve 14. In a case where the rotor part is in a stopped state, fixed shaft 17 and bearing sleeve 14 are brought into a contact state in arbitrary positions of dynamic pressure generating grooves 20a or 20b. When the rotor part begins rotation, in dynamic pressure generating grooves 20a and 20b, dynamic pressure proportional to the number of rotations is generated, and fixed shaft 17 support bearing sleeve 14 in a noncontact state via gas or fluid with predetermined bearing rigidity. In this way, a radial bearing of bearing sleeve 14 for fixed shaft 17 is formed. A bearing configuration with both-end supporting structure is obtained by constructing two sets of dynamic pressure generating grooves in the abutting surfaces between fixed shaft 17 and bearing sleeve 14 as in this embodiment. By adopting the fixed-shaft type motor as in this embodiment, such a bearing with both-end supporting structure can be formed near the center of gravity of the whole rotary body including polygon mirror 11. Therefore, the suppressing effect of precession can be enhanced. In particular, the suppressing effect of precession can be further enhanced by arranging the two sets of dynamic pressure generating grooves, respectively, so that the axial center position of the two sets of dynamic pressure generating grooves becomes an axial position of the center of gravity of the rotor part.

Thrust plate 15 made of resin is arranged at the upper end of the inner peripheral side of bearing sleeve 14, and bearing sleeve 14 receives fixed shaft 17 in the thrust direction via thrust plate 15. In thrust plate 15, for example, a spiral groove is provided, and a dynamic pressure bearing in a thrust direction for fixed shaft 17 is formed. Thrust plate 15 is directly fixed to bearing sleeve 14 by caulking an upper circumferential portion of bearing sleeve 14 by a caulking method. Thereby, bearing thrust portion 16 that is a bearing in the thrust direction which is thrust-hermetically sealed is formed. Especially, in the polygon motor of this embodiment, the weight of the whole rotary body including the rotor part is reduced. Therefore, the load of bearing thrust portion 16 can be reduced, and a thrust receiving reinforcing plate or the like which has conventionally been required in order to reinforce a thrust plate can be eliminated. For this reason, bearing thrust portion 16 can be formed in this way by a simple working method, and the number of parts can be reduced.

By the configuration described above, fixed shaft 17 fixed to base substrate 19 rotatably supports bearing sleeve 14 to which rotor frame 12 is fastened, with predetermined bearing rigidity.

Next, rotor frame 12 is formed, for example, by pressing a zinc-plated steel sheet. Moreover, bearing sleeve 14 is fixed at the center of the top surface portion of rotor frame 12 by at least one of press fit, bonding, or welding, and thereby, rotor frame 12 and bearing sleeve 14 are fastened together.

Three convex projections 12a are formed on the top surface portion of rotor frame 12 by punching work. The centers of projections 12a are arranged at equal intervals on an imaginary circle which is concentric with bearing sleeve 14. Especially, since polygon mirror 11 is loaded on projections 12a as described above, the precision of a reference plane formed at distal ends of three projections 12a become important. In order to realize the high-precision reference plane formed at such distal ends of three projections 12a, in this embodiment, these projections 12a are formed by the following working method. That is, three projections 12a are formed by receiving and fixing the top surface portion of rotor frame 12 by a jig whose flatness is finished with high precision, and pressing a jig with three-portion punches with equal pressure to each punch from above. Projections 12a which realizes a high-precision reference plane are formed by such a working method.

In addition, although an example in which three projections 12a are formed on the top surface portion of rotor frame 12 has been given and described in this embodiment, a configuration may be provided which has at least three projections 12a on the top surface portion. That is, a configuration may be provided such that a reference plane is formed by three predetermined projections 12a out of a plurality of projections 12a, three projections 12a abut on polygon mirror 11 and polygon mirror 11 is placed by so-called three-point supporting. Although an example in which these projections 12a are arranged at equal intervals on an imaginary circle which is concentric with bearing sleeve 14 has been given as described, an arrangement may be provided such that polygon mirror 11 can be stably arranged, without being necessarily arranged at equal intervals on an imaginary circle. In this embodiment, the plane of polygon mirror 11 is received by three projections 12a with minimum number and best stability which specifies the plane. However, the plane of polygon mirror 11 may be received by three or more projections 12a as long as the height precision between a plurality of projections 12a can be sufficiently secured.

The polygon motor of this embodiment, as shown in FIGS. 1 and 2 is configured to have stepped portion 12b in which a height difference is given to the peripheral edge of the top surface portion of rotor frame 12. By such a configuration, it is possible to increase the rigidity of rotor frame 12 by stepped portion 12b. Therefore, the influence of distortion of the reference plane having projections 12a of rotor frame 12 caused by the centrifugal force during high-speed rotation can be suppressed.

Polygon mirror 11 is placed at the distal end of projections 12a of rotor frame 12 described above, i.e., on a reference plane which is virtually formed.

In this embodiment, in order to keep the plane tilting, axis tilting, and eccentricity of polygon mirror 11 which are placed on rotor frame 12 with high precision, bearing sleeve 14, rotor frame 12, and polygon mirror 11 are integrated by the following method.

That is, while bearing sleeve 14 and rotor frame 12 are regulated by a jig, and are concentrically aligned with each other, a clearance fitting portion which is between bearing sleeve 14 and rotor frame 12 is bonded and fixed with an adhesive.

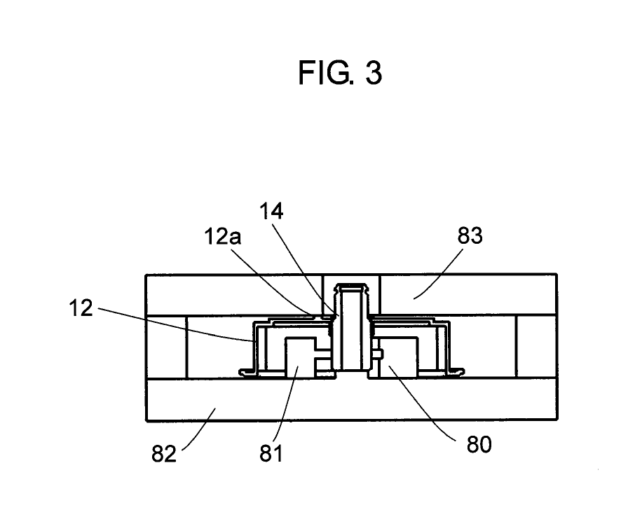

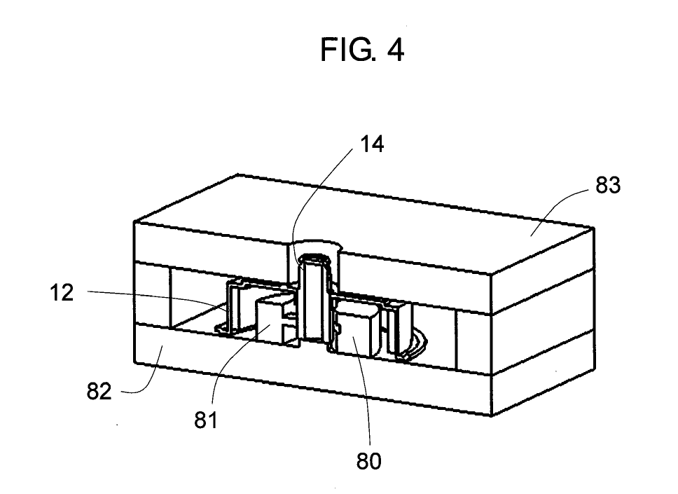

FIGS. 3 and 4 shows an aspect in which bearing sleeve 14 and rotor frame 12 are fixed by a jig, FIG. 3 shows a cross-section thereof and FIG. 4 shows an oblique direction thereof. In FIGS. 3 and 4, frame regulating jig 83 is a jig, such as a magnet, which magnetically attracts rotor frame 12. Rotor frame 12 is regulated so that projections 12a may contact frame regulating jig 83, respectively. Meanwhile, bearing sleeve 14 is arranged at receiving jig 82 having a protrusion which receives the opening of the sleeve, and is regulated by chuck jig 80 and hold-down jig 81. Frame regulating jig 83, receiving jig 82, chuck jig 80, and hold-down jig 81 have sufficient perpendicularity in advance.

By the respective jigs with such perpendicularity, the concentric alignment between bearing sleeve 14 and rotor frame 12 is performed, and bearing sleeve 14 and rotor frame 12 are bonded and fixed with an adhesive.

Moreover, polygon mirror 11 is arranged on projections 12a of rotor frame 12, and polygon mirror 11 is fixed onto three projections 12a by hold-down spring 21. By integrating bearing sleeve 14, rotor frame 12, and polygon mirror 11 by this method, vertical accuracy with respect to fixed shaft 17 can be raised, and it is possible to keep the plane tilting, axis tilting, and eccentricity of polygon mirror 11 with high precision. By adopting a configuration in which polygon mirror 11 is supported by three projections 12a provided on rotor frame 12 in this way, it is not necessary to provide a flange, a rotor boss, etc. which have conventionally been required in order to support polygon mirror 11, and it is possible to reduce the weight and thickness of the whole rotary body including bearing sleeve 14 and rotor frame 12. Since the position of the center of gravity of the whole rotary body becomes low, the whirling motion of the rotor during high-speed rotation can also be suppressed. Since the clearance between polygon mirror 11 and rotor frame 12 can be reduced, wind noise during rotation can also be reduced. Since polygon mirror 11 is configured so as to pass through bearing sleeve 14, it is not necessary to make small the internal diameter of the hole of polygon mirror 11 for allowing bearing sleeve 14 to pass therethrough, and it is also not necessary to interpose spacers, such as a rotor boss, as in the conventional technique. Also, since rotor magnet 13 is configured so as to be covered with rotor frame 12 made of a magnetic metal material, breakage of rotor magnet 13 resulting from the centrifugal force during high-speed rotation can be prevented.

As described above, the polygon mirror scanner motor in the embodiment of the invention includes rotor frame 12 having rotor magnet 13 cylindrically arranged thereon, bearing sleeve 14 fastened to the center of rotor frame 12, fixed shaft 17 having one end fixed to base substrate 19, and the other end for rotatably supporting bearing sleeve 14, and polygon mirror 11 placed on rotor frame 12. Rotor frame 12 has at least three projections 12a on its one surface, and has polygon mirror 11 placed thereon in abutment with projections 12a. Since a fixed-shaft type structure is obtained by adopting having such a configuration, generation of precession can be suppressed. Moreover, by adopting a configuration in which polygon mirror 11 is supported by projections 12a provided on the top surface of rotor frame 12, it is not necessary to provide a flange, a rotor boss, etc. which have conventionally been required in order to support the polygon mirror, and it is possible to reduce the weight and thickness of the whole rotary body. Additionally, since the position of the center of gravity of the whole rotary body becomes low, the whirling motion of the rotor during high-speed rotation can also be suppressed. Accordingly, according to the invention, it is possible to provide a polygon mirror scanner motor which is also adapted to high-speed rotation and high-speed starting by reducing weight while the plane tilting, axis tilting, and eccentricity of the polygon mirror are kept with high precision by lowering the position of the center of gravity.

### INDUSTRIAL APPLICABILITY

According to the invention, since the polygon mirror scanner motor which is also adapted to high-speed rotation and high-speed starting can be provided, the invention is suitable for a polygon mirror scanner motor used for laser scanning of a laser printer, a laser copying machine, etc.

1. A polygon mirror scanner motor comprising a stator part loaded on a base substrate, and including a stator core around which a stator coil is wound, and a rotor part including a rotor magnet arranged to face the stator core, and having a polygon mirror loaded thereon,
wherein the rotor part includes a rotor frame formed in the shape of a cup, made by a magnetic metal material and having the rotor magnet arranged on the inner peripheral side of a cylindrical portion thereof, a bearing sleeve fastened to the center of the rotor frame, and a polygon mirror placed on the rotor frame,
wherein the stator part includes a fixed shaft having one end fixed to the base substrate,
wherein the bearing sleeve is rotatably supported at the other end of the fixed shaft, and
wherein the rotor frame has at least three projections on its one surface, and has the polygon mirror placed thereon in abutment with the projections.

2. The polygon mirror scanner motor of claim 1,
wherein the rotor frame has the polygon mirror placed thereon in abutment with the three projections.

3. The polygon mirror scanner motor of claim 1,
wherein the polygon mirror is pressed against and fixed onto to the projections by a hold-down spring fixed to the bearing sleeve.

4. The polygon mirror scanner motor of claim 1,
wherein two sets of dynamic pressure generating grooves are provided in an inner peripheral surface of the bearing sleeve or in the shaft surface of the fixed shaft.

5. The polygon mirror scanner motor of claim 4,
wherein the two sets of dynamic pressure generating grooves are arranged so that the axial center position of the two sets of dynamic pressure generating grooves becomes the axial position of the center of gravity of the rotor part.

6. The polygon mirror scanner motor of claim 1,
wherein the rotor frame has a stepped portion in which a height difference is given to the peripheral edge of a surface with the projections.

7. The polygon mirror scanner motor of claim 1,
wherein the portion of the bearing sleeve at the other end of the fixed shaft has a thrust plate made of resin directly fixed thereto, and the other end of the fixed shaft is supported in the thrust direction by the thrust plate.

8. The polygon mirror scanner motor of claim 1,
wherein the fixed shaft is fixed to the base substrate by laser welding.

9. The polygon mirror scanner motor of claim 1,
wherein the rotor frame and the bearing sleeve are fastened together by using at least one of press fitting, bonding, or welding.
